(19) United States
(12) Patent Application Publication
(10) Pub. No.: US 2026/0338821 A1
(43) Pub. Date: Oct. 29, 2026

(54) SYSTEM AND METHOD FOR COLLABORATIVE LINK PROCESSING IN WIRELESS TRANSCEIVER-BASED MOTION DETECTION

(71) Applicants: GLEB VODOVOZOV, SINGAPORE (SG); MICHEL ALLEGUE MARTINEZ, TERREBONNE (CA)

(72) Inventors: GLEB VODOVOZOV, SINGAPORE (SG); MICHEL ALLEGUE MARTINEZ, TERREBONNE (CA)

(21) Appl. No.: 19/705,782

(22) Filed: Jun. 11, 2026

Related U.S. Application Data
(63) Continuation of application No. 18/584,134, filed on Feb. 22, 2024.
(63) Continuation of application No. 18/435,480, filed on Feb. 7, 2024.
(63) Continuation of application No. 18/508,869, filed on Nov. 14, 2023.
Application No. 18/435,480 is a continuation of application No. 18/124,347, filed on Mar. 21, 2023, now Pat. No. 11,916,635.
Application No. 18/124,347 is a continuation of application No. 17/392,678, filed on Aug. 3, 2021, now Pat. No. 11,611,382.
Application No. 18/508,869 is a continuation of application No. 17/347,754, filed on Jun. 15, 2021, now Pat. No. 11,842,613.
Application No. 18/584,134 is a continuation of application No. 16/798,148, filed on Feb. 21, 2020, now Pat. No. 11,913,970.
Application No. 17/392,678 is a continuation of application No. 16/795,219, filed on Feb. 19, 2020, now Pat. No. 11,082,109.
Application No. 17/347,754 is a continuation of application No. 16/303,301, filed on May 31, 2017, now Pat. No. 11,043,094.
(60) Provisional application No. 62/347,217, filed on Jun. 8, 2016.
(60) Provisional application No. 62/809,436, filed on Feb. 22, 2019.
(60) Provisional application No. 62/809,421, filed on Feb. 22, 2019.
(60) Provisional application No. 62/809,393, filed on Feb. 22, 2019.

(51) Int. Cl. G01P 13/00; G08B 13/00; H04W 84/12; H04W 88/02

(52) U.S. Cl. CPC G01P 13/00; G08B 13/00; H04W 84/12; H04W 88/02

(57) ABSTRACT

A wireless motion detection system and method performs collaborative processing of motion-related wireless measurement data from multiple spatially related sensing links formed among wireless transceivers. The sensing links may be unidirectional, bidirectional, or both, and may use channel state information (CSI) amplitude and/or phase, RSSI, link-quality, channel-response, Doppler-related, time-of-flight, or other propagation-sensitive measurements. A central or distributed aggregator analyzes data from multiple links together to determine motion, presence, occupancy, activity, zone-transition, trajectory, or likelihood values. When forward-path and reverse-path data are available, bidirectional correlation may be used to reject unidirectional radio noise artifacts. Temporal correlation may maintain motion-state continuity across spatially adjacent links without resetting a time-based detection filter.

### FIELD OF THE INVENTION

This patent application claims the benefit of priority as a continuation of U.S. patent application Ser. No. 18/508,869 filed Nov. 14, 2023; which itself claims the benefit of priority to U.S. patent application Ser. No. 17/347,754 filed Jun. 15, 2021 which has issued as U.S. Pat. No. 11,842,613; which itself claims the benefit of priority to U.S. patent application Ser. No. 16/303,301 filed Nov. 20, 2018 which has issued as U.S. Pat. No. 11,043,094; which itself claims the benefit of priority to World Intellectual Property Organization Patent Application PCT/CA2017/000136 filed May 31, 2017; which itself claims the benefit of priority to U.S. Provisional Patent Application 62/347,217 filed Jun. 8, 2016; the entire contents of each being herein incorporated by reference.

This patent application claims the benefit of priority as a continuation of U.S. patent application Ser. No. 18/435,480 filed Feb. 7, 2024; which itself claims the benefit of priority to U.S. patent application Ser. No. 18/124,347 filed Mar. 21, 2023 which has issued as U.S. Pat. No. 11,916,635; which itself claims the benefit of priority to U.S. patent application Ser. No. 17/392,678 filed Aug. 3, 2021 which has issued as U.S. Pat. No. 11,611,382; which itself claims the benefit of priority to U.S. patent application Ser. No. 16/795,219 filed Feb. 19, 2020 which has issued as U.S. Pat. No. 11,082,109; which itself claims priority to U.S. Provisional Patent Applications 62/809,393 filed Feb. 22, 2019 and 62/809,421 filed Feb. 22, 2019; the entire contents of each being herein incorporated by reference.

This patent application claims the benefit of priority as a continuation of U.S. patent application Ser. No. 18/584,134 filed Feb. 22, 2024; which itself claims the benefit of priority to U.S. patent application Ser. No. 16/798,148 filed Feb. 21, 2020 which has issued as U.S. Pat. No. 11,913,970; which itself claims priority to U.S. Provisional Patent 62/809,436 filed Feb. 22, 2019; the entire contents of each being herein incorporated by reference.

### FIELD OF THE INVENTION

This patent application relates to motion detection and more particularly wireless signal based motion detection and even more particularly to collaborative processing of wireless link data from multiple wireless links simultaneously.

### BACKGROUND OF THE INVENTION

Wireless signal-based motion detection systems utilize changes in the characteristics of radio frequency signals propagating in an environment caused by moving objects within the environment to detect their presence and their motion. As an object moves through the space within which wireless signals are propagating between a pair of wirelessly communicating transceivers, the object causes changes in the multipath propagation environment, resulting in measurable variations in signal characteristics such as channel state information (CSI) amplitude and/or phase values at the receiving transceiver(s). These signal variations can be analyzed to detect and characterize motion without requiring the object to have or carry any device or tag that would receive-transmit-process or simply reflect the wireless signals.

Prior art wireless motion detection systems employ a star network architecture in which a central hub node communicates with a plurality of peripheral sensor nodes via individual communication links. Each communication link is processed independently, i.e. the hub or sensor node analyzes signal disturbances on a single link in isolation and reports a motion detection result based solely on the measurements from that link. Such independent per-link processing approach has several significant limitations.

A first limitation is that with motion from one sensing zone (covered by one link) to an adjacent sensing zone (covered by a different link), the independent per-link system must reset its time-based detection filter for the new link and begin accumulating fresh evidence of motion. This reset introduces a detection gap during which the system fails to report continuous motion, resulting in increased detection latency and fragmented motion tracking. For rapid motion events where the object crosses multiple link boundaries in quick succession, these detection gaps can cause the system to miss the object completely or significantly impact-delay the detection of its continuous motion path.

A second limitation is that the processing is susceptible to false positive detections caused by noise artifacts within the wireless link. Transient interference events, hardware noise in the transmitter or receiver circuitry, and interference from external sources can cause momentary signal disturbances on a single link that resemble the signal patterns caused by actual motion. Because independent per-link systems analyze each link in isolation, they cannot distinguish between genuine bidirectional motion-induced signal changes and unidirectional noise artifacts that affect only one direction of a communication link.

Accordingly, there exists a requirement for a wireless motion detection system that addresses these foregoing limitations in order to distinguish true motion events from radio noise artifacts and maintain motion state continuity when motion transitions between spatially adjacent sensing zones.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to motion detection and more particularly wireless signal based motion detection and even more particularly to collaborative processing of wireless link data from multiple wireless links simultaneously.

In accordance with an embodiment of the invention there is provided a method of providing a wireless motion detection system comprising:
establishing a sensing layer comprising a number of wireless sensing links between a number of wireless devices associated with an environment where a portion of the number of wireless devices comprise either a wireless receiver or a wireless transceiver for receiving wireless signals or wireless packets from either one or more other wireless transceivers within the portion of the number of wireless devices or one or more wireless transmitters within another portion of the number of wireless devices;
transmitting propagation-sensitive wireless measurements from each wireless device of the portion of the number of wireless devices which comprise either a wireless receiver or a wireless transceiver to a central aggregator via a number of links forming a coordination layer; and
executing a process upon the central aggregator comprising the steps of:
   receiving the motion-related wireless measurement data from each wireless device of the portion of the number of wireless devices which is either a wireless receiver or a wireless transceiver from the number of links forming the coordination layer;
   perform collaborative processing by analyzing the motion-related wireless measurement data from multiple spatially related wireless sensing links together; and
   determine a motion state based on simultaneous collaborative analysis of the motion-related wireless measurement data from the plurality of wireless sensing links; wherein
each wireless device of the portion of the number of wireless devices comprising either the wireless receiver or the wireless transceiver extracts wireless signal characteristics from the received wireless packets or signals received over the wireless sensing link of the number of wireless sensing links comprising either the wireless receiver or the wireless transceiver and establishes propagation-sensitive wireless measurements independence upon the extracted wireless signal characteristics.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a conventional star network architecture for wireless motion sensing according to prior art, showing a central node communicatively coupled to a plurality of nodes via individual communication links, wherein each sensor node independently transmits motion-related data to the central node for processing;

FIG. 2 illustrates a wireless transceiver architecture with collaborative link processing according to an embodiment of the invention with unidirectional, bidirectional, or a combination thereof with the transceivers establishing a mesh topology;

FIG. 3 illustrates detecting a motion path showing continuous motion tracking capability enabled by collaborative link processing without temporal reset delays according to an embodiment of the invention; and

FIG. 4 illustrates a collaborative multi-sensor processing architecture exploiting wireless-link disturbance metrics from wireless sensing links together with auxiliary sensor data from sensors to establish spatially and temporally related sensing evidence streams to determine motion, presence, occupancy, activity, zone-transition, trajectory, or associated likelihood values according to an embodiment of the invention.

### DETAILED DESCRIPTION

The present invention is directed to motion detection and more particularly wireless signal based motion detection and even more particularly to collaborative processing of wireless link data from multiple wireless links simultaneously.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

Reference to terms such as “first”, “second”, etc. or “other”, “another” “further” etc. may be used herein to describe various devices, components, elements, or other items, such devices, components, elements, or other items are not employed to limit by these devices, components, elements, or other items etc. The terms are employed used to distinguish one of a type of item from another of the same or similar type of item within the description.

Any statement herein that a device, component, element or other item is “configured to” perform an action means that the device, component, element or other item- or some part (or parts) of the item are capable of performing such action and have the requisite physical and/or processing elements necessary to perform the action.

A “wireless standard” as used herein and throughout this disclosure, refer to, but is not limited to, a standard for transmitting signals and/or data through electromagnetic radiation which may be optical, radio-frequency (RF) or microwave although typically RF wireless systems and techniques dominate. A wireless standard may be defined globally, nationally, or specific to an equipment manufacturer or set of equipment manufacturers. Dominant wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Thread, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella. Thread being secure, low-power wireless mesh networking technology for Internet of Things (IoT) devices for example.

A “wired standard” as used herein and throughout this disclosure, generally refer to, but is not limited to, a standard for transmitting signals and/or data through an electrical cable discretely or in combination with another signal. Such wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G. hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to move within an environment exploiting one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

An “artificial intelligence system” (referred to hereafter as artificial intelligence, AI) as used herein, and throughout this disclosure, refers to machine intelligence or machine learning in contrast to natural intelligence. An AI may refer to analytical, human inspired, or humanized artificial intelligence. An AI may refer to the use of one or more machine learning algorithms and/or processes. An AI may employ one or more of an artificial network, decision trees, support vector machines, Bayesian networks, and genetic algorithms. An AI may employ a training model or federated learning.

“Machine Learning” (ML) or more specifically machine learning processes as used herein refers to, but is not limited, to programs, algorithms or software tools, which allow a given device or program to learn to adapt its functionality based on information processed by it or by other independent processes. These learning processes are in practice, gathered from the result of said process which produce data and or algorithms that lend themselves to prediction. This prediction process allows ML-capable devices to behave according to guidelines initially established within its own programming but evolved as a result of the ML. A machine learning algorithm or machining learning process as employed by an AI may include, but not be limited to, supervised learning, unsupervised learning, cluster analysis, reinforcement learning, feature learning, sparse dictionary learning, anomaly detection, association rule learning, inductive logic programming.

A “signal disturbance metric” as used herein, and throughout this disclosure, refers to a quantitative measure of a variation in one or more wireless signal characteristics, such as the variance, standard deviation, rate of change, a Doppler-related variation, or other statistical measure of the one or more wireless signal characteristics.

A “wireless signal characteristic” as used herein, and throughout this disclosure, refers a measurable or quantifiable characteristic of a wireless signal or sets of wireless signals. A wireless characteristic may include, but not be limited to, instantaneous channel state information (CSI) (or short-term CSI), statistical CSI (or long-term CSI), amplitude, phase, sub-carrier CSI, received-signal-strength indicator (RSSI), link-quality, or propagation-sensitive values across one or more packets, sub-carriers, antennas, frequency bands, or time windows.

An “intermediate motion detection result” as used herein, and throughout this disclosure” may comprise a binary indicator, scalar disturbance value, feature vector, statistical summary, time-stamped event candidate, optional confidence value, or any combination thereof which is indicative of detection of motion.

Wireless signal-based motion detection systems utilize changes in the characteristics of radio frequency signals propagating in an environment caused by moving objects within the environment to detect their presence and their motion. As an object moves through the space within which wireless signals are propagating between a pair of wirelessly communicating transceivers, the object causes changes in the multipath propagation environment, resulting in measurable variations in signal characteristics such as channel state information (CSI) amplitude and/or phase values at the receiving transceiver(s). These signal variations can be analyzed to detect and characterize motion without requiring the object to have or carry any device or tag that would receive-transmit-process or simply reflect the wireless signals.

Prior art wireless motion detection systems employ a star network architecture in which a central hub node communicates with a plurality of peripheral sensor nodes via individual communication links. Each communication link is processed independently, i.e. the hub or sensor node analyzes signal disturbances on a single link in isolation and reports a motion detection result based solely on the measurements from that link. Such independent per-link processing approach has several significant limitations.

A first limitation is that with motion from one sensing zone (covered by one link) to an adjacent sensing zone (covered by a different link), the independent per-link system must reset its time-based detection filter for the new link and begin accumulating fresh evidence of motion. This reset introduces a detection gap during which the system fails to report continuous motion, resulting in increased detection latency and fragmented motion tracking. For rapid motion events where the object crosses multiple link boundaries in quick succession, these detection gaps can cause the system to miss the object completely or significantly impact-delay the detection of its continuous motion path.

A second limitation is that the processing is susceptible to false positive detections caused by noise artifacts within the wireless link. Transient interference events, hardware noise in the transmitter or receiver circuitry, and interference from external sources can cause momentary signal disturbances on a single link that resemble the signal patterns caused by actual motion. Because independent per-link systems analyze each link in isolation, they cannot distinguish between genuine bidirectional motion-induced signal changes and unidirectional noise artifacts that affect only one direction of a communication link.

Accordingly, there exists a requirement for a wireless motion detection system that addresses these foregoing limitations in order to distinguish true motion events from radio noise artifacts and maintain motion state continuity when motion transitions between spatially adjacent sensing zones. The inventors have established a system, method and process for such wireless motion detection by performing collaborative processing of multiple wireless sensing links simultaneously or concurrently whether the multiple wireless sensing links are synchronous, asynchronous or plesiochronous with respect to each other. The system, method and process optionally applying bidirectional correlation analysis where both forward-path and reverse-path measurements are available to distinguish true motion events from radio noise artifacts and maintaining motion state continuity when motion transitions between spatially adjacent sensing zones.

### REFERENCE TO RELATED APPLICATION

U.S. patent application Ser. No. 19/201,421 entitled “Systems and Methods for Wireless Signal based Multi-Layered Activity Monitoring, Fall Detection and Prediction in Indoor Environments”, which has published as U.S. Patent Application Number 2025/0349197 is hereby incorporated by reference.

U.S. patent application Ser. No. 18/075,208 entitled “Monitoring Activity using Wi-Fi Motion Detection”, which has issued as U.S. Pat. No. 11,864,061 is hereby incorporated by reference.

U.S. patent application Ser. No. 17/524,024 entitled “Proximity-based Model for Indoor Localization using Wireless Signals”, which has issued as U.S. Pat. No. 12,520,112 is hereby incorporated by reference.

U.S. patent application Ser. No. 18/519,361 entitled “System and Method for Presence and Pulse Detection from Wireless Signals”, which has issued as U.S. Pat. No. 12,638,551 is hereby incorporated by reference.

U.S. patent application Ser. No. 18/584,134 entitled “Wireless Detection using Multiband Filters”, which has published as U.S. Patent Application Number 2024/0192248 is hereby incorporated by reference.

U.S. patent application Ser. No. 18/435,480 entitled “Self-Learning Based Wi-Fi Based Monitoring and Augmentation”, which has published as U.S. Patent Application Number 2024/0178894 is hereby incorporated by reference.

U.S. patent application Ser. No. 18/438,864 entitled “Handling Concept Drift in Wi-Fi-based Localization”, which has issued as U.S. Pat. No. 12,520,107 is hereby incorporated by reference.

U.S. patent application Ser. No. 16/003,044 entitled “Systems and Methods for Sensing an Environment with Wireless Communication Signals”, which has issued as U.S. Pat. No. 10,447,415 is hereby incorporated by reference.

U.S. patent application Ser. No. 16/715,053 entitled “System, Method and Apparatus for Sensing Changes in an Environment using Wireless Communication Signals”, which has issued as U.S. Pat. No. 11,115,788 is hereby incorporated by reference.

U.S. patent application Ser. No. 18/526,656 entitled “System and Methods for Identifying a Subject through Device-Free and Device-Oriented Sensing Technologies”, which has issued as U.S. Pat. No. 12,640,024 is hereby incorporated by reference.

U.S. patent application Ser. No. 18/508,869 entitled “System and Methods for Smart Intrusion Detection using Wireless signals and Artificial Intelligence”, which has published as U.S. Patent Application Publication 2024/0078886 is hereby incorporated by reference.

U.S. patent application Ser. No. 18/410,440 entitled “Device-Free Subject Localization Methods and Systems Using Wireless Signals”, which has issued as U.S. Pat. No. 12,607,702 is hereby incorporated by reference.

U.S. patent application Ser. No. 18/481,470 entitled “Device-Free Localization Methods within Smart Indoor Environment”, which has issued as U.S. Pat. No. 12,627,948 is hereby incorporated by reference.

U.S. patent application Ser. No. 16/807,776 entitled “Using Over-the Air Signals for Passive Motion Detection”, which has issued as U.S. Pat. No. 10,928,503 is hereby incorporated by reference.

U.S. patent application Ser. No. 17/329,621 entitled “Detecting a Location of Motion Using Wireless Signals that Propagate Along Two or More Paths of a Wireless Communication Channel”, which has issued as U.S. Pat. No. 12,156,096 is hereby incorporated by reference.

U.S. patent application Ser. No. 18/185,851 entitled “Systems and Methods for Motion Detection using Sensing Transmission”, which has issued as U.S. Pat. No. 12,038,493 is hereby incorporated by reference.

Within the prior art techniques for wireless signal-based motion detection have been presented using over-the-air wireless signals between a wireless receiver and a wireless transmitter as well as processes for exploiting wireless signals propagating along two or more paths of a wireless communication channel. The systems, methods and processes outlined below within this disclosure extended prior art wireless motion detection concepts by exploiting what the inventors refer to as “collaborative multi-link processing” together with bidirectional correlation for noise rejection, temporal continuity across adjacent sensing zones and correlation of heterogeneous sensing evidence streams.

Within an embodiment of the invention there is provided a wireless motion detection system comprising a plurality of wireless transceivers configured to transmit and receive wireless signals over a plurality of wireless sensing links which propagate directly and indirectly through an environment. The wireless sensing links may include unidirectional or bidirectional links and the wireless transceivers may be arranged in a topology which may for example be a mesh network or ring network although other topologies may be supported within embodiments of the invention. Within other embodiments of the invention the topology may be comprise a number of wireless transmitters and a number of wireless receivers discretely or in conjunction with a number of wireless transceivers.

Within embodiments of the invention each wireless device supporting one or more of a wireless receiver, wireless transmitter and wireless transceiver may be a fixed electronic device, a portable device or a wearable device. Within embodiments of the invention where the wireless devices include a portable device or a wearable device then data associated with their channel links may only be processed and aggregated for the detection and/or characterization of motion if motion of the wireless device is zero over the period of time data is acquired or below a predetermined velocity threshold such that the motion of the wireless device does not impart an error above a defined level. Within embodiments of the invention the velocity threshold may be established in dependence upon the number of wireless links the system is processing for the environment as the error arising from a single link within a collaborative multi-link processing set may reduce with increasing link count.

Within embodiments of the invention each wireless device supporting one or more of a wireless receiver, wireless transmitter and wireless transceiver may be a fixed electronic device, a portable device or a wearable device where all wireless links within a collaborative multi-link processing set may be of one wireless standard. Within another embodiment of the invention the wireless links within the collaborative multi-link processing set may be according to two or more wireless standards that each support a defined metric, a define set of metrics, extraction of a define metric or extraction of a defined set of metrics.

Within the embodiments of the invention as described below the wireless transceivers (hereinafter transceivers) are implemented as nodes arranged in a mesh-like topology using IEEE 802.11 (Wi-Fi) with sensing links allowing for Channel State Information (CSI) based motion detection. In alternative embodiments, the collaborative processing architecture may be applied to any arrangement of wireless transceivers and/or wireless protocols capable of producing channel, link-quality, phase, amplitude, received-signal-strength, time-of-flight, Doppler, or other propagation-sensitive measurements suitable for motion or occupancy detection. The coordination of measurement data or intermediate results between transceivers and an aggregator may be carried over any suitable short-range wireless or wired protocol, including but not limited to Wi-Fi, Zigbee, Thread, Bluetooth Low Energy, Z-Wave, Ethernet, or sub-GHz protocols.

In another aspect of the present disclosure, the present invention provides a wireless motion detection system configured to perform collaborative processing of multiple wireless sensing links simultaneously for improved motion sensing accuracy and speed. The invention may employ any suitable arrangement of wireless transceivers with wireless sensing links between them, wherein the links may be unidirectional, bidirectional, or a combination thereof, and wherein each link measures signal disturbances caused by motion-induced changes in radio frequency propagation.

In certain embodiments, the system further comprises a temporal correlation module that maintains motion state continuity when a subject transitions from a first communication link to a spatially adjacent second link. The temporal correlation module eliminates the need to reset time-based detection filters when motion crosses link boundaries, enabling the system to immediately recognize continuous motion paths without accumulation delays.

In some embodiments, the central aggregator executes a weighted voting algorithm wherein each link's contribution to the final motion determination is weighted based on signal quality metrics including signal-to-noise ratio and link stability, ensuring that high-quality measurements dominate the collaborative decision while still incorporating information from all available links for comprehensive coverage.

In alternative embodiments, the central aggregator function may be implemented as distributed processing logic replicated across multiple transceivers, wherein each transceiver performs partial aggregation of results from neighboring or spatially related links and exchanges aggregated data with peer transceivers to achieve collaborative decision-making without a single centralized processing point.

In further embodiments, the system incorporates adaptive threshold adjustment mechanisms that modify bidirectional correlation parameters based on historical noise patterns observed on each link, enabling the system to dynamically optimize detection sensitivity in response to changing environmental conditions.

In yet further embodiments, the system includes a generalized collaborative sensor processing layer configured to receive auxiliary sensor data from one or more non-CSI or non-RF sensing modalities, including passive infrared (PIR) sensors, millimeter wave (mmWave) radar sensors, ultrasonic sensors, thermal array sensors, acoustic sensors, contact sensors, camera-derived occupancy metadata, or other environmental sensors. The central aggregator treats the wireless-link results and auxiliary sensor results as spatially and temporally related sensing evidence streams, and applies multi-modal correlation to determine whether detected events correspond to a common physical motion event, a false positive, or a continuation of a previously detected motion path.

The foregoing aspects provide reduced detection latency, reduced false-positive susceptibility, and improved motion, presence, occupancy, activity, zone-transition, and trajectory determination in applications involving wireless sensing networks, wireless transceiver arrangements, and optional heterogeneous sensor inputs.

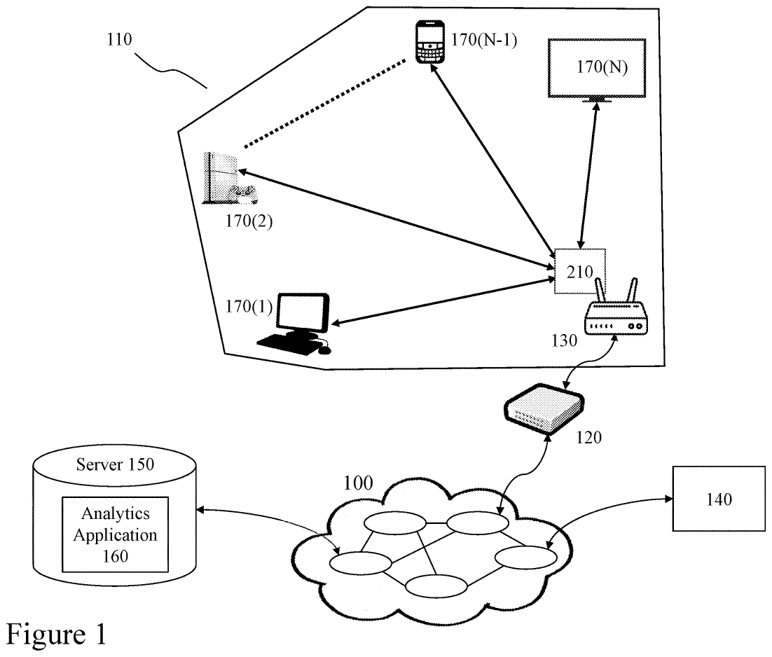

As noted above embodiments of the invention provide wireless motion detection systems that employ collaborative processing of motion-related wireless measurements from multiple spatially related communication links to achieve improved detection speed, reduced false positive rates, and improved continuity of motion-state determination. In broad embodiments, the multiple communication links may include unidirectional links, bidirectional links, or a combination of unidirectional and bidirectional links. When forward-path and reverse-path measurements are available for a given spatial link, the system may additionally perform bidirectional correlation to distinguish true motion events from radio-frequency noise artifacts. This collaborative approach contrasts with conventional star network architectures such as that depicted in FIG. 1 that process individual links in isolation, resulting in detection delays when motion transitions between sensing zones and elevated false alarm rates from transient radio noise events.

As depicted in FIG. 1 the a region, Environment 110, is defined by a number N Devices 170(1) to 170(N) which communicate with a Wi-Fi Router 130 such that wireless signals propagate between each of the N Devices 170(1) to 170(N) and the Wi-Fi Router 130. If the region around the N Devices 170(1) to 170(N) is an external environment then the Environment 110 is essentially defined by the region between the N Devices 170(1) to 170(N) and the Wi-Fi Router 130. If the region around the N Devices 170(1) to 170(N) is an internal environment then the wireless signals from the N Devices 170(1) to 170(N) may propagate and be reflected from walls, surfaces etc. such that the Environment 110 is defined by the physical boundary(ies) within which the N Devices 170(1) to 170(N) are deployed/disposed. The wireless signals received by the Wi-Fi Router 130 may be processed by the Wi-Fi Router 130 directly to extract the wireless signal characteristics which are then subsequently processed through one or more software processes/algorithms to define motion of one or more objects within the Environment 110. This subsequent processing, for motion determination, which is hereinafter referred to as PREMOD, may be performed at the Wi-Fi Router 130 or the extracted wireless characteristics may be pushed from the Wi-Fi Router 130 to a Server 150 upon which an Analytics Application 160 is in execution via a Router 120 and Network 100. The extracted wireless characteristics may also be pushed to a Remote Processing Node 140 which may be associated with a social network, service provider, third party service provider, a user, an enterprise, an organizations or a government entity.

Where the Wi-Fi Router 130 receives wireless signals and extracts wireless characteristics from them then the wireless characteristic data employed in the subsequent processing is from wireless links that are unidirectional. If, however, the N Devices 170(1) to 170(N) extract wireless characteristics from the wireless signals received from the Wi-Fi Router 130 and then transmits these back to the Wi-Fi Router 130 then the wireless characteristic data employed in the subsequent processing is from bidirectional wireless links. However, as evident all the wireless links are to/from the Wi-Fi Router 130 such that the interconnections from the Wi-Fi Router 130 to the N Devices 170(1) to 170(N) form a star network architecture as all links radiate from a central node.

### Embodiment 1

### System Architecture

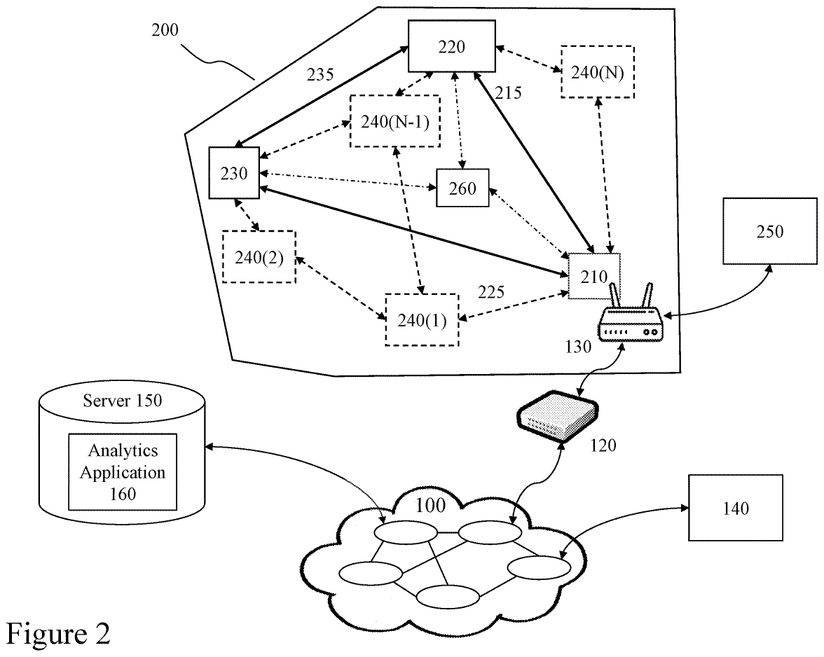

Now referring to FIG. 2 there is depicted a wireless signal-based motion detection Environment 200 according to an illustrated embodiment comprises a first Wireless Transceiver 210 forming part of Wi-Fi Router 130, a second Wireless Transceiver 220, and a third Wireless Transceiver 230 arranged in a wireless sensing architecture. The illustrated arrangement may be mesh-like, but the invention is not limited to a mesh topology or to any particular network arrangement. The first Wireless Transceiver 210 and second Wireless Transceiver 220 are interconnected by a first Wireless Sensing Link 215, the second Wireless Transceiver 220 and third Wireless Transceiver 230 are interconnected by a second Wireless Sensing Link 225, and an optional third Wireless Sensing Link 235 may be established between the first Wireless Transceiver 210 and third Wireless Transceiver 230, providing additional redundancy and sensing coverage. Any of the wireless sensing links may be unidirectional or bidirectional depending on resource constraints, network configuration, available radios, packet-scheduling requirements, power budget, or a desired maximum number of incoming sensing links at a particular transceiver. In certain preferred embodiments, at least some of the links are bidirectional to enable bidirectional correlation for noise rejection, while the broader collaborative processing architecture remains applicable when one or more links are unidirectional.

Also depicted are N Devices 240(1) to 240(N) which may communicate with each other, with one of the first to third Wireless Transceivers 210, 220 and 230 or with the Wi-Fi Router 130. These additional devices and potential links being depicted in dashed lines. The first to third Wireless Transceivers 210, 220 and 230 communicate with the Wi-Fi Router 130 over Wi-Fi links at 2.4 GHz and/or 5 GHz according to the transceiver devices within these devices. However, the wireless links between each of the first to third Wireless Transceivers 210, 220 and 230 and the Wi-Fi Router 130 with the N Devices 240(1) to 240(N) or between devices within the N Devices 240(1) to 240(N) may be via Wi-Fi at 2.4 GHz and/or 5 GHz although they may be via one or more other wireless protocols including Bluetooth, Zigbee, or another wireless standard or a custom protocol. In this manner the wireless signals from which data is extracted may be according to two or more different wireless protocols.

Within an embodiment of the invention a wireless transceiver, such as third Wireless Transceiver 230 for example, may accumulate wireless signal characteristics for a number of links, namely:
from the Wi-Fi Router 130 over the second Wireless Sensing Link 225;
from the second Wireless Transceiver 220 over optional third Wireless Sensing Link 235;
from second Device 240(2); and
from N−1 Device 240(N−1).

The third Wireless Transceiver 230 may also receive wireless signal characteristics for other links it is not directly part of but for which a device linked to the third Wireless Transceiver 230 is linked, such as:
from first Device 240(1) for its link to second Device 240(2);
from first Device 240(1) for its link to N-1 Device 240(N−1); and
from N−1 Device 240(N−1) for its link to second Wireless Transceiver 220.

Accordingly, the wireless signal characteristics may be extracted from a mesh network of wireless devices wherein each link within the mesh network may be via a defined wireless protocol which may be the same as that of other links or different such that if we consider the mesh network as being between a number N devices with a number R links between the number M devices then the number R links may be of S different protocols where N, R and S are positive integers. A number M devices of the number N devices within the mesh network may perform local processing the extracted wireless signal characteristics to establish intermediate motion detection results which are then communicated to a central aggregator device of the number N devices, such as the Wi-Fi Router 130 in FIG. 2, which performs further processing to establish motion detection results or pushes to one or both of a Local Processing Node 250 and Remote Processing Node 140. These motion detections results may be communicated form the Wi-Fi Router 130 to the Network 100 via Router 120 and therein to a server, such as Server 150 in FIG. 1 or another server for storage and use in performing one or more actions.

The aggregation and processing may be structured such that multiple Environments 200 are analysed by common processing, e.g. one or more of Local Processing Node 250, Remote Processing Node 140 and Analytics Application 160 on Server 150. Alternatively an Environment 200 may be analysed by dedicated processing resources. An aggregator may be employed for multiple Environments 200 or each Environment 200 may have a discrete aggregator.

Alternatively, the intermediate motion detection results are communicated to the central aggregator device and therein to the Remote Processing Node 140.

Alternatively, the intermediate motion detection results are communicated to the central aggregator device and therein to a Local Processing Node associated with the Environment 200, such as for example an alarm system or smart home control hub.

Whilst the ensuing description above and below describe and depict a central aggregator device within other embodiments of the invention the aggregation may be distributed with each aggregator device pushing data to remote analytics modules, devices or algorithms for processing, such as Analytics Application 160 on Server 150 in FIG. 1 or pushed to a local analytics modules, devices or algorithms for processing

Within embodiments of the invention a portion of the wireless devices employed in collaborative link based motion detection may fixed electronic devices fixed in location and wireless devices may be added, removed or re-located periodically to reflect the ongoing requirements of one or more users within the Environment 200 to employ these wireless devices. Within some embodiments of the invention a portion of the fixed devices within the Environment 200 may be semi-permanently located as they form part of the infrastructure of a building, security system etc.

With embodiments of the invention a portion of the wireless devices employed in collaborative link based motion detection may portable or wearable electronic devices which are temporarily positioned and their location may change with some degree of regulatory as well as they may be added, removed or re-located to reflect the ongoing requirements of one or more users within the Environment 200 to employ these wireless devices. As noted above the inclusion of wireless link characteristics of one or more wireless links within the collaborative link based motion detection processing may be established based upon motion of the wireless device being zero over the period of time data is acquired or below a predetermined velocity threshold such that the motion of the wireless device does not impart an error above a defined level. The determination of the motion of the wireless device being established in dependence upon data from one or more sensors associated with the wireless device such as an accelerometer, GNSS receiver etc. wherein the wireless device embeds velocity data into its transmissions such that a receiving wireless device can filter the extracted wireless link characteristics based upon this velocity data before embedding into the data set employed for wireless motion detection. Alternatively, the wireless device itself may filter the extracted wireless link characteristics based upon this velocity data before embedding it into the data set employed for wireless motion detection. For example, a user may be wearing a smartwatch with a Wi-Fi interface and extracted wireless link characteristics are employed when the smartwatch is stationary, e.g. the user is sitting, laying down, standing in one location for a period of time etc., but when the user moves from one location to another the extracted wireless link characteristics are ignored in the wireless motion detections processing and then are employed again once the user stops moving.

Within embodiments of the invention a system may employ a two-layer communication architecture comprising a sensing layer and a coordination layer. Whilst a two-layer architecture is described it would be evident that three or more layers may also be employed with one layer being the coordination layer with each other layer being a sensing layer according to a different wireless protocol or standard.

In an embodiment, the sensing layer uses IEEE 802.11 (Wi-Fi) links between transceivers to perform CSI-based motion detection. Wi-Fi CSI provides per-subcarrier amplitude and/or phase measurements that are sensitive to motion-induced multipath changes and may be used as the basis for signal disturbance metrics described herein. In other embodiments, the collaborative processing architecture may be applied to wireless technologies capable of producing propagation-sensitive measurements suitable for motion or occupancy detection, including measurements derived from received signal strength, link quality, phase, Doppler, time-of-flight, or channel response. The coordination layer, which carries intermediate motion detection results between transceivers and to the central aggregator, may be implemented over any suitable short-range wireless or wired protocol, including but not limited to IEEE 802.11, IEEE 802.15.4-based protocols such as Zigbee and Thread, Bluetooth Low Energy (BLE), Z-Wave, Ethernet, or proprietary sub-GHz protocols. In deployments where the same Wi-Fi links serve both sensing and coordination, no additional hardware is required. In deployments where a separate low-power protocol is preferred for coordination, the transceivers may include a secondary radio for that purpose. The selection of coordination protocol does not alter the collaborative processing architecture of the present invention.

Each wireless transceiver measures signal characteristics including channel state information (CSI) amplitude and/or phase values, received signal strength indicator (RSSI), link-quality values, channel-response values, Doppler-related features, time-of-flight values, or other propagation-sensitive measurements on received wireless packets or signals on the sensing links. Motion-induced changes in the radio frequency propagation environment cause measurable changes in such propagation-sensitive measurements at the receiving transceiver. The measurements may be used locally to generate intermediate motion detection results, or may be sent in raw or partially processed form to the central aggregator device for centralized computation. The data forwarded to the central aggregator may therefore include raw measurement samples, filtered measurement samples, feature vectors, statistical summaries, signal disturbance metrics, time-stamped event candidates, confidence values, intermediate motion detection results, or combinations thereof. These data are forwarded via the coordination network, which may operate on a different wireless or wired protocol than the sensing links.

Each wireless transceiver may comprise wireless radio circuitry capable of transmitting and/or receiving wireless signals and, in preferred embodiments, an IEEE 802.11 (Wi-Fi) radio chipset capable of extracting CSI measurements from received packets, a microprocessor or microcontroller for local signal processing, and memory for storing firmware, configuration data, and runtime processing buffers. Transceivers may optionally include a secondary radio (e.g., Zigbee, Thread, or BLE) dedicated to coordination and result-reporting communications, allowing the Wi-Fi radio to be reserved exclusively for sensing. The transceivers may be configured to continuously or periodically transmit and receive wireless packets or signals on the sensing links and to extract CSI amplitude and/or phase measurements, RSSI, link-quality, channel-response, Doppler-related, time-of-flight, or other propagation-sensitive measurements from received packets or signals. Intermediate motion detection results or other motion-related wireless measurement data are transmitted to the central aggregator via the coordination network.

The Environment 200 may further comprise a central aggregator that is communicatively coupled to the wireless transceivers. In the illustrated embodiment of FIG. 2, the central aggregator functionality may be implemented by a wireless transceiver, such as the third Wireless Transceiver 230, Wi-Fi Router 130 or Aggregator Node 260. Accordingly, the central aggregator may perform the dual functions of being a wireless transceiver maintaining one or more sensing links and a central processing hub or it may be implemented as a separate standalone device that communicates with the wireless transceivers via wired connections, such as Ethernet for example, or via additional wireless links for example. Alternatively, the central aggregator may be implemented as a gateway, server, or cloud service.

The central aggregator, such as Aggregator Node 260 for example, comprises processing circuitry and memory storing executable instructions. The processing circuitry may be implemented as a microprocessor, a microcontroller, a digital signal processor (DSP), a field-programmable gate array (FPGA), an application-specific integrated circuit (ASIC), a system-on-chip (SoC), an embedded Linux processor, a cloud processor, or combinations thereof. The memory may comprise non-volatile storage for storing firmware and configuration data and volatile working memory for runtime processing buffers. The amount of memory and processing capacity may vary widely depending on whether the aggregator receives raw measurements, partially processed features, or intermediate motion detection results, and may range from resource-constrained embedded implementations to higher-performance gateway, server, or cloud implementations. Accordingly, no particular processor speed or memory capacity is required unless expressly recited in a claim.

The processing circuitry of the central aggregator, such as Aggregator Node 260 for example, is configured to receive motion-related wireless measurement data from each of a plurality of wireless sensing links formed among the wireless transceivers. The received data may comprise raw propagation-sensitive measurements, partially processed measurement streams, feature vectors, statistical summaries, signal disturbance metrics, binary motion indicators, time-stamped event candidates, optional confidence values, or combinations thereof. In implementations where individual transceivers have limited processing capability or where centralized computation is preferred, the transceivers may transmit raw or lightly processed data to the central aggregator, and the central aggregator may compute the disturbance metrics and motion classifications. In other implementations, each transceiver locally analyzes the signal characteristics on its received wireless packets or signals and generates an intermediate motion detection result for each link on which it serves as a receiver. For bidirectional links, the central aggregator may receive data corresponding to both directions of the link. These data are transmitted to the central aggregator, such as Aggregator Node 260 for example, at regular intervals, for example every 10 milliseconds to a few seconds, to enable real-time collaborative processing.

A signal disturbance metric employed by each wireless transceiver may be derived from Wi-Fi CSI measurements, for example, and may include the variance or standard deviation of CSI amplitude and/or phase values across multiple IEEE 802.11 subcarriers, computed over a sliding time window of configurable duration.

The central aggregator, such as Aggregator Node 260 for example, performs collaborative processing by simultaneously analyzing the intermediate motion detection results received from multiple active wireless sensing links. This collaborative approach enables the system to apply cross-link correlation algorithms that consider the spatial and temporal relationships between motion events detected on different links. By aggregating data from multiple links at a single decision point, the system achieves faster and more accurate motion determinations compared to systems that process each link independently and sequentially.

### Embodiment 2

### Bidirectional Correlation for Noise Filtering

In embodiments in which a wireless sensing link is bidirectional, a key inventive feature of the system is the bidirectional correlation mechanism implemented by the central aggregator, such as Aggregator Node 260 for example,. This mechanism leverages the bidirectional nature of the wireless communication link to distinguish true motion events from false positives caused by radio frequency noise artifacts. The bidirectional correlation analysis is performed for each bidirectional link by comparing signal disturbances measured on both the forward and reverse directions of the link.

For the first Wireless Sensing Link 215, the central aggregator, such as Aggregator Node 260 for example, receives two sets of intermediate motion detection data: forward direction data representing signal disturbances measured at the second Wireless Transceiver 220 when receiving transmissions from the first wireless transceiver 210, and reverse direction data representing signal disturbances measured at the first Wireless Transceiver 210 when receiving transmissions from the second Wireless Transceiver 220. Similarly, for the second Wireless Sensing Link 225, the aggregator receives forward direction data from the third Wireless Transceiver 230 and reverse direction data from the second Wireless Transceiver 220.

True physical motion events typically affect radio frequency propagation bidirectionally. When a person walks through the space between the first Wireless Transceiver 210 and second Wireless Transceiver 220, the user's body causes changes in the multipath propagation environment that impact both the forward path (first Wireless Transceiver 210 to second Wireless Transceiver 220) and the reverse path (second Wireless Transceiver 220 to first Wireless Transceiver 210) in a correlated manner. Consequently, both the forward direction data and reverse direction data for first Wireless Sensing Link 215 will show elevated signal disturbances during the motion event. The disturbances on the two directions may not be identical in magnitude due to differences in transmit power, antenna patterns, and receiver sensitivity between the nodes, but they will exhibit temporal correlation and will both exceed baseline noise levels.

The bidirectional correlation analysis does not require the forward-path and reverse-path disturbance metrics to be equal in magnitude. Correlation may be determined based on temporal overlap, relative increase above baseline, matched event timing, matched trend direction, similarity of normalized disturbance values, optional confidence-value correspondence, or any combination thereof. This accommodates differences in transmit power, antenna pattern, receiver sensitivity, automatic gain control behavior, packet timing, bandwidth, and hardware impairments between nodes.

In contrast, radio frequency noise artifacts often affect only one direction of a bidirectional link. Several types of noise events exhibit this unidirectional characteristic. First, transmitter-side noise occurring at the first Wireless Transceiver 210 (such as power supply fluctuations, local interference from other electronic devices, or hardware malfunctions in the transmit circuitry) will cause elevated signal variance in the forward direction of link 215 but will not affect the reverse direction because the second Wireless Transceiver 220's transmitter operates independently. Second, receiver-side noise at the second Wireless Transceiver 220 (such as analog-to-digital converter quantization errors, automatic gain control instabilities, or local interference affecting the receive circuitry) will manifest as elevated variance in the forward direction measurements at Wireless Transceiver 220 but will not appear in the reverse direction measurements at Wireless Transceiver 210. Third, transient interference from external sources may affect only one node's receiver depending on the spatial proximity and directionality of the interference source.

The signal disturbance metric may be computed as the variance, standard deviation, rate of change, temporal derivative, spectral feature, Doppler-related feature, or other statistical measure of CSI or other propagation-sensitive measurements over a sliding time window.

This bidirectional correlation mechanism provides significant reduction in false positive susceptibility. In some experimental or representative implementations, systems employing bidirectional correlation achieved lower false positive rates than comparable single-direction analysis systems while maintaining substantially equivalent true positive detection rates. The reduction in false positives is particularly pronounced in environments with elevated radio frequency interference or in deployments using lower-cost hardware components that exhibit greater transmitter and receiver noise.

In certain embodiments, the bidirectional correlation algorithm incorporates adaptive threshold adjustment. The central aggregator, such as Aggregator Node 260 for example, maintains historical statistics on the noise characteristics observed on each direction of each link, including baseline noise levels during periods of no motion and the frequency and magnitude of unidirectional noise events. Based on these statistics, the aggregator dynamically adjusts the thresholds T1 and T2 to optimize the tradeoff between detection sensitivity and false positive rejection. For example, if a particular link consistently experiences elevated unidirectional noise during certain times of day (e.g., due to nearby industrial equipment operating on a schedule), the aggregator may increase the thresholds for that link during those time periods.

### Embodiment 3

### Continuous Motion Path Tracking

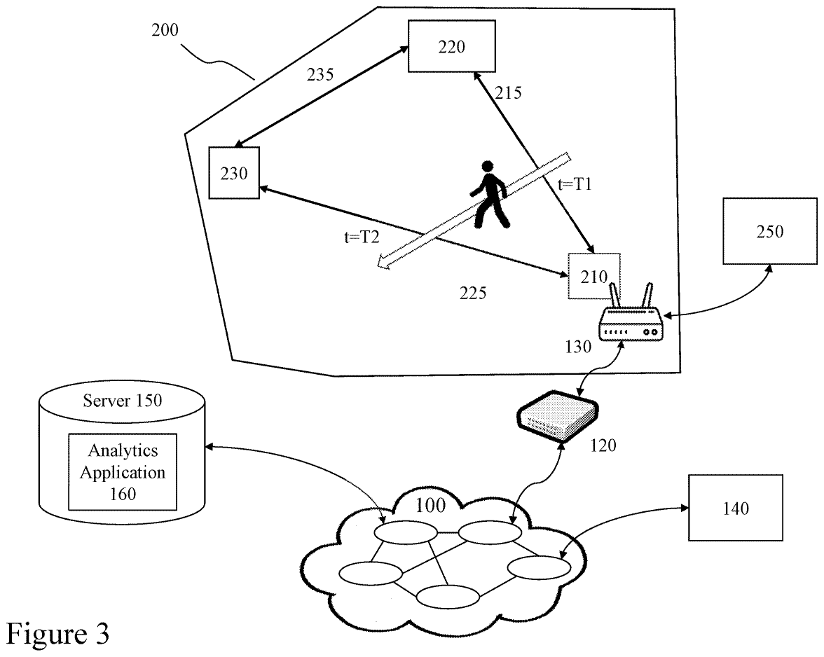

Referring to FIG. 3, the system is configured to track continuous motion paths across multiple wireless sensing links without temporal reset delays. FIG. 3 illustrates a use case scenario wherein a User (U1) 310 crosses or moves close to the first Wireless Sensing Link 215 at time T1 and subsequently crosses or moves close to the second Wireless Sensing Link 225 at time T2. This scenario represents a common real-world situation where a user moves through a monitored space in a continuous trajectory that sequentially affects multiple sensing zones. It would be evident to one of skill in the art that “crosses or moves close to” within the context of wireless signals means that wireless signals from a wireless transceiver to another wireless transceiver are affected by the User (U1) 310 such that the user's body blocks all or part of a wireless signal, attenuates all or part of a wireless signal, induces a phase shift of all or part of a wireless signal, reflects or partially reflects all or part of a wireless signal. As wireless signals radiate and propagate according to the antenna radiation pattern of the transmitting antenna and may reflect off surfaces a user may be “crossing or moving close” to a wireless link over an extended area but for ease of this description the wireless links are assumed to be narrow beams of limited angular coverage from the antenna.

Within prior art wireless motion detection systems that process each link independently, each link typically employs a time-based filter to reduce false positives. The time-based filter requires that signal disturbances persist for a minimum duration (e.g., 2 to 3 seconds) before the system reports a motion detection event. This filtering approach is effective at rejecting brief transient noise events, but it creates a significant problem when motion transitions rapidly from one link to another. When the User 310 moves from the first Wireless Sensing Link 215 to the second Wireless Sensing Link 225, the prior art system must reset the time-based filter for the second Wireless Sensing Link 225 and begin accumulating new evidence of motion on that link. During the filter accumulation period, the system experiences a detection gap, as it knows that motion occurred on first Wireless Sensing 215, but it has not yet confirmed motion on second Wireless Sensing Link 225, even though the two events are part of a single continuous motion path of the user. This detection gap results in increased latency and may cause the system to miss or fragment the detection of fast-moving subjects.

In contrast, the present invention solves this problem through a temporal correlation module implemented as part of the processing logic executing on the central aggregator, such as Aggregator Node 260 for example,. The temporal correlation module maintains motion state information across multiple links concurrently, e.g. first and second Wireless Links 215 and 225 respectively, and analyzes the spatial and temporal relationships between motion events to identify continuous motion paths. When Wireless Sensing Link 215 (the first wireless sensing Wireless Sensing Link 215) registers a motion detection event at time T1, the temporal correlation module records the following information: the identity of the link on which motion was detected, the timestamp T1 of the detection, the spatial location of the link (i.e., which nodes the link connects), and optionally the direction or trajectory of motion inferred from the signal characteristics.

When the second wireless sensing Wireless Sensing Link 225 subsequently registers signal disturbances at time T2, the temporal correlation module performs the following analysis before applying the standard time-based filter. First, the module calculates the time difference ΔT=T2−T1 between the current disturbance on second Wireless Sensing Link 225 and the most recent motion event on first Wireless Sensing Link 215. Second, the module determines the spatial relationship between the first Wireless Sensing Link 215 and the second Wireless Sensing Link 225 by examining the known or estimated spatial relationship among the sensing links or transceivers. In the illustrated embodiment of FIG. 3, first Wireless Sensing Link 215 and Wireless Sensing Link 225 are spatially adjacent because they share the common first Wireless Transceiver 210. More generally, two links are considered spatially adjacent if they share at least one common transceiver or if the physical distance between the links is below a predetermined threshold (e.g., 5 to 10 meters).

If the time difference ΔT is less than a predetermined motion transition threshold (typically in the range of 0.5 to 2 seconds) and the second Wireless Sensing Link 225 is spatially adjacent to the first Wireless Sensing Link 215, then the temporal correlation module determines that the signal disturbance on Wireless Sensing Link 225 is a continuation of the motion event that originated on Wireless Sensing Link 215, rather than an independent new motion event. In this case, the module maintains motion state continuity, i.e. it recognizes the user's movement from first Wireless Sensing Link 215 to second Wireless Sensing Link 225 without requiring second Wireless Sensing Link 225 to independently satisfy the full time-based filter criteria. The system outputs a continuous motion detection signal indicating that motion has transitioned from Wireless Sensing Link 215 to Wireless Sensing Link 225, and it may optionally infer the user's trajectory or direction of travel based on the sequence of link activations.

This temporal correlation approach enables seamless tracking of fast-moving subjects and reduces overall detection latency. In some experimental or representative implementations, systems employing temporal correlation achieved lower detection latency than independent per-link processing systems, with notable improvements observed for rapid motion events where the time between link transitions was short. The temporal correlation mechanism is particularly advantageous in applications such as smart home automation, security monitoring, and elderly care monitoring.

In certain embodiments, the temporal correlation module implements a state machine that tracks the current motion state across the plurality of wireless sensing links. The state machine maintains variables including: (1) a list of links that are currently experiencing motion, (2) the timestamp of the most recent motion detection on each link, (3) a predicted trajectory based on the sequence of link activations, and (4) a confidence score for the continuous motion hypothesis. The state machine is updated in real-time as new intermediate motion detection results or motion-related wireless measurement data are received from the wireless transceivers, and it generates motion path events that applications can use to trigger automated responses or to visualize user movement patterns.

### Embodiment 4

### Weighted Voting Aggregation Algorithm

The central aggregator, such as Aggregator Node 260 for example, may employ a weighted voting algorithm to determine the final motion state based on the intermediate motion detection results received from multiple active wireless sensing links. The weighted voting approach ensures that the system's decision is dominated by high-quality, reliable measurements while still incorporating information from all available links for comprehensive spatial coverage. This algorithm is particularly important in deployments where different links may experience varying signal quality due to differences in transceiver placement, environmental conditions, or hardware characteristics.

The weighted voting algorithm as employed within an embodiment of the invention may operates as follows. For each wireless sensing link i in the system (where 1≤i≤N, and N is the total number of active links), the central aggregator, such as Aggregator Node 260 for example, calculates a weighting factor Wᵢ based on multiple signal quality metrics. The weighting factor Wᵢ is a numerical value typically ranging from 0.0 (indicating that link i would have minimal influence on the final decision) to 1.0 (indicating that link i would have high influence). The weighting factor Wᵢ is calculated, for example, based upon the following considerations.

First, the signal-to-noise ratio (SNR) of link i is evaluated. Links with higher signal-to-noise ratios (SNR) provide more reliable motion detection because the signal variations caused by motion are more easily distinguished from background noise. The SNR for a link is calculated as the ratio of the average received signal power during normal operation to the average noise power measured during periods of no transmission or during calibration. The weighting factor component based on SNR may be computed by Equation (1) where SNR_{REF} is a reference SNR value (e.g., 20 dB) representing good signal quality.

W_snr(i)=min(SNRᵢ/SNR_{REF}) (1)

Second, the link stability of link i is assessed. Link stability refers to the consistency of the wireless communication link over recent history, including metrics such as packet loss rate, frequency of disconnections, and variance in baseline signal levels. A stable link that maintains consistent connectivity and signal characteristics receives a higher weighting factor than an unstable link that experiences frequent dropouts or erratic behavior. The weighting factor component based on stability may be computed as W_Stability(i)=1−PacketLossRate(i) where PacketLossRateᵢ is the fraction of transmitted packets that are not successfully received (e.g., a packet loss rate of 0.05 or 5% yields W_Stability(i)=1).

Third, spatial coverage factors may be considered in certain applications. For example, in a smart home deployment, links that cover high-traffic areas such as doorways, hallways, or staircases may be assigned higher weights because motion is more likely to occur in those areas. The spatial weighting component W_Spatial(i) is application-specific and may be configured by the system installer based on the floor plan and expected usage patterns.

The overall weighting factor for link i is computed as a combination of these components, for example, Wᵢ=α⋅W_SNR(i)+β⋅W_Stability(i)+γ⋅W_Spatial(i), where α, β, γ are tunable parameters satisfying a relationship, e.g. α+β+γ=1, where in an implementation, equal weighting is given to SNR and stability (i.e. α=β=0.4) with a smaller contribution from spatial factors (γ=0.2).

The central aggregator, such as Aggregator Node 260 for example, obtains the intermediate motion detection result Mᵢ for each link i from the wireless transceivers. If the intermediate results are binary indicators, Mᵢ may be 0 or 1. If the intermediate results are scalar values, feature-derived values, or optional confidence values, Mᵢ may be normalized to a range from 0.0 to 1.0. The aggregator computes a weighted contribution Cᵢ for each link as the product of the weighting factor and the intermediate result: Cᵢ=Wᵢ·Mᵢ.

The final motion score is computed as the weighted average of all link contributions: MotionScore=sum(Cᵢ)/sum(Wᵢ), where the summations are taken over all active links 1≤i≤N. This formula ensures that the final score is a normalized value in the range [0.0, 1.0], where 0.0 indicates no motion detected and 1.0 indicates definite motion detected.

9] The final motion state is determined by comparing the final motion score to a predetermined decision threshold T_{DECISION}. If the final motion score exceeds T_{DECISION} (typically set to 0.5 for binary decisions or adjusted based on the desired sensitivity), the system outputs a “Motion Detected” state. Otherwise, the system outputs a “No Motion” state. The decision threshold T_{DECISION} may be adjusted by the user or by adaptive algorithms to control the tradeoff between detection sensitivity and false alarm rate.

0] This weighted voting approach provides several advantages. First, it ensures that the system's motion detection decision is robust to localized failures or degraded performance on individual links, even if one or two links experience poor signal quality or temporary malfunctions, the remaining high-quality links can still produce an accurate motion determination. Second, it enables the system to achieve comprehensive spatial coverage by incorporating information from all available links, including links with moderate signal quality that would be unreliable if used in isolation. Third, the weighting mechanism naturally adapts to changing environmental conditions, if a particular link's signal quality degrades over time (e.g., due to physical obstruction or interference), its weighting factor will decrease automatically, reducing its influence on the final decision.

### Working Example

To illustrate the operation of the invention, consider a working example corresponding to the embodiment shown in FIG. 2. The system comprises three wireless transceivers arranged in a triangular wireless sensing architecture. The first Wireless Transceiver 210 and second Wireless Transceiver 220 are connected by the first wireless sensing link 215, the second Wireless Transceiver 220 and third Wireless Transceiver 230 are connected by the second wireless sensing Link 225, and the first Wireless Transceiver 210 and third Wireless Transceiver 230 are optionally connected by the third wireless sensing link 235. In some implementations, one or more of the wireless sensing links are bidirectional. The third Wireless Transceiver 230, or another device, may serve as the central aggregator, such as Aggregator Node 260 for example,.

In the working example, each node, as an example of a wireless transceiver, measures the Wi-Fi channel state information (CSI) amplitude and/or phase for each received IEEE 802.11 data packet and calculates the standard deviation or other statistical variation measure of CSI amplitude and/or phase values over a 1-second sliding window encompassing approximately 20 packet measurements at a sensing rate of 20 Hz. The computed standard deviation serves as the signal disturbance metric and is subsequently reported to the central aggregator over the coordination channel, which may be the same Wi-Fi link or a separate low-power radio (e.g., Zigbee or Thread).

### Technical Advantages and Effects

The invention provides several significant technical advantages over prior art wireless motion detection systems. First, the collaborative multi-link processing architecture can reduce detection latency, particularly for motion events that transition rapidly between sensing zones. In some implementations, the latency reduction is attributable to the temporal correlation mechanism, which eliminates the need to reset and re-accumulate time-based filters when motion crosses link boundaries. This advantage is especially important in applications requiring fast response times, such as automated lighting control, security alarm systems, and elderly fall detection.

Second, the bidirectional correlation mechanism can reduce false positive susceptibility. By rejecting unidirectional radio noise events that would trigger false alarms in single-direction analysis systems, the invention improves practical deployment reliability without requiring substantially more complex signal processing algorithms or additional hardware. The false-positive reduction is achieved by comparing spatially related forward and reverse transmission-path evidence, rather than analyzing each path in isolation.

Third, the inventive approach allows for inclusion of links according to any wireless protocol or standard rather than exploiting only wireless signals according to a single standard or protocol. In this manner the inventive architecture can exploit wireless transceivers according multiple protocols or standards without requiring a substantial number of wireless transceivers of a single common protocol or standard.

Fourth, the temporal correlation capability enables accurate tracking of continuous motion paths across multiple links, improving motion detection accuracy in applications involving fast-moving subjects or complex movement patterns. Prior art systems that process each link independently may fail to recognize that multiple sequential motion events are part of a single continuous trajectory, leading to fragmented or incomplete motion tracking. The present invention solves this problem by maintaining motion state continuity across spatially adjacent links, enabling the system to reconstruct complete motion paths and infer user trajectories.

Fifth, the weighted voting aggregation algorithm ensures robust decision-making in the presence of varying signal quality across different links. By automatically weighting each link's contribution based on SNR, stability, and spatial factors, the algorithm ensures that high-quality measurements dominate the collaborative decision while still incorporating information from all available links for comprehensive coverage. This approach is superior to simple majority voting or unweighted averaging, which would give equal influence to both high-quality and low-quality measurements.

### Embodiment 5

### Optional Collaborative Multi-Sensor Processing

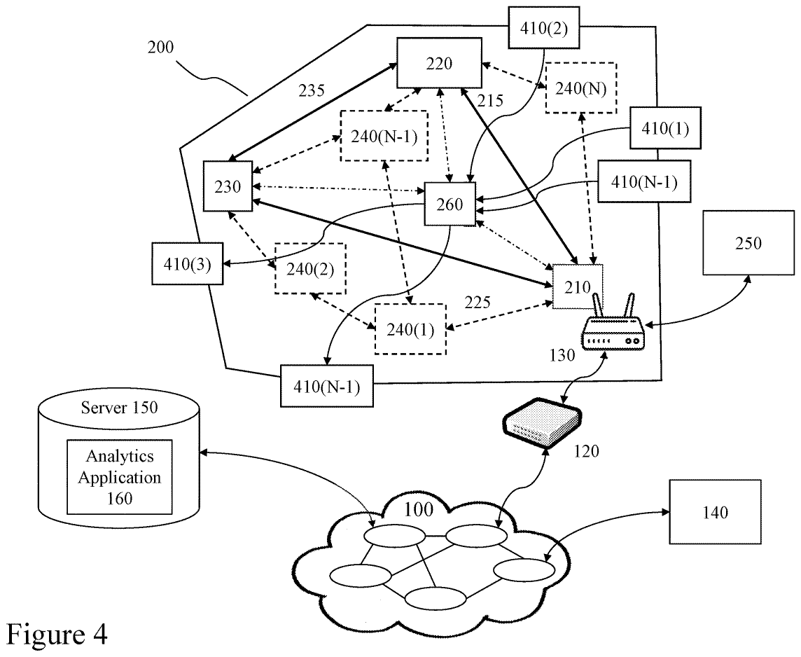

Referring to FIG. 4, in an optional and separate embodiment, the collaborative processing architecture may be generalized so that the central aggregator, such as Aggregator Node 260 for example, or distributed aggregation logic replicated across multiple wireless transceivers, receives and processes data from one or more auxiliary sensors in addition to wireless-link disturbance metrics, illustrated in Figure as metrics from first to third Wireless Sensing Links 215, 225, and 235, respectively which may be unidirectional and/or bidirectional wireless links. This embodiment is not required for the core collaborative wireless-link processing invention, but may be used to provide additional confirmation, classification, or false-positive rejection in deployments that include auxiliary sensing modalities as provided by first to N Sensors 401(1) to 410(N). Each sensor of the first to N Sensors 401(1) to 410(N) may be, but not be limited to, a passive infrared (PIR) sensors, a millimeter wave (mmWave) radar sensor, an ultrasonic sensor, a thermal array sensors, an acoustic sensor, a contact sensor, a camera-based vision sensor, an environmental sensor, or combination thereof.

The central aggregator, such as Aggregator Node 260 for example, comprises a multi-sensor correlation module configured to perform collaborative processing across heterogeneous data sources. The multi-sensor correlation module treats the wireless-link results and the auxiliary sensor results as spatially and temporally related sensing evidence streams. The correlation module compares the data streams to determine whether detected events represent a common physical motion event, a false positive, a continuation of a previously detected motion path, or a separate independent event. Alternatively, each sensor of the first to N Sensors 401(1) to 410(N) may communicate data to the Aggregator Node 260 via a device comprising a wireless transceiver, such as first to third Wireless Transceivers 210, 220 and 230, via a device of the N Devices 240(1) to 240(N) or via the Wi-Fi Router 130 for example. Within other embodiments of the invention wired interfaces may be employed to couple data to a local node that couples of a device associated with the Environment 200.

Each auxiliary sensor may be associated with a known or estimated spatial coverage region and may produce an auxiliary sensor data stream. The auxiliary sensor data stream may include raw sensor samples, filtered sensor measurements, binary event flags, object range estimates, object velocity estimates, Doppler signatures, thermal change values, acoustic-event indicators, contact-state changes, camera-derived occupancy metadata, sensor identifiers, timestamps, spatial coverage identifiers, optional confidence values, or combinations thereof.

The multi-sensor correlation module may apply weighted voting, Bayesian inference, rule-based logic, state-machine logic, neural-network classification, or other data fusion techniques to combine wireless-link results and auxiliary sensor results. The weighting assigned to each data stream may depend on sensor type, sensor reliability, signal-to-noise ratio, historical false-positive rate, spatial overlap with a detected link event, time alignment with other detected events, or application-specific priority.

The auxiliary sensor data may also be used to reject false positives. For example, when a wireless link exhibits a unidirectional disturbance that fails the bidirectional correlation check and no auxiliary sensor having overlapping spatial coverage reports a temporally corresponding event, the aggregator may classify the disturbance as likely radio noise. Conversely, when a PIR sensor or mmWave radar reports an event in a spatial region that overlaps a bidirectional wireless link having correlated forward and reverse disturbances, the aggregator may increase the likelihood that the event represents true human motion or occupancy.

The generalized multi-sensor embodiment does not require that every deployment include all sensor types. Rather, the collaborative processing architecture treats each available sensing modality as an input source that may contribute evidence to a shared motion, presence, occupancy, activity, zone-transition, direction-of-travel, or trajectory determination. Thus, the system can operate with only Wi-Fi CSI sensing links, with Wi-Fi CSI links plus one auxiliary modality, or with a plurality of heterogeneous auxiliary sensor modalities.

### Alternative Embodiments and Variations

While the foregoing description has focused on an illustrated embodiment employing three wireless transceivers in a triangular sensing arrangement, it will be understood by those skilled in the art that the invention is not limited to this specific configuration or to a mesh topology. The system may comprise two, three, four, five, six, or more wireless transceivers arranged in any suitable topology or spatial relationship, including point-to-point arrangements, star arrangements, partial mesh arrangements, full mesh arrangements, line arrangements, square grids, hexagonal patterns, or irregular configurations optimized for specific room layouts. The key requirement is that multiple wireless sensing links exist among the transceivers and that motion-related wireless measurement data from multiple links are processed collaboratively at a central aggregator or through distributed aggregation logic.

In alternative embodiments, the central aggregator function may be distributed across multiple wireless transceivers rather than being concentrated in a single transceiver or device. In a distributed aggregation architecture, each transceiver performs partial aggregation of intermediate results from neighboring or spatially related links and exchanges aggregated data with peer transceivers through the wireless coordination network. Each transceiver maintains a local view of the motion state based on nearby links and collaborates with other transceivers to build a global motion state. This distributed approach eliminates a single point of failure and may improve scalability in large deployments with many transceivers covering expansive areas. The distributed aggregation logic can implement the same bidirectional correlation, temporal correlation, and weighted voting algorithms described above, but the computations are partitioned across multiple processing devices.

In certain embodiments, the system incorporates adaptive learning capabilities that optimize detection parameters based on observed motion patterns and noise characteristics in specific deployment environments. For example, a machine learning module may analyze historical data to identify recurring noise patterns (such as periodic interference from nearby equipment) and automatically adjust the bidirectional correlation thresholds to suppress those specific noise signatures. Similarly, the system may learn typical motion trajectories in a particular environment (such as common walking paths in a home or office) and adjust the spatial weighting factors to favor links that align with those trajectories. The adaptive learning module may employ supervised learning techniques (trained on labeled motion/no-motion ground truth data), unsupervised learning techniques (such as clustering algorithms to identify distinct motion patterns), or reinforcement learning techniques (optimizing parameters based on feedback from user corrections of false positives and false negatives).

In further embodiments, the system may employ frequency diversity by operating on multiple wireless frequency bands simultaneously. For example, wireless transceivers implementing IEEE 802.11 may maintain bidirectional links on both the 2.4 GHz and 5 GHz bands, while transceivers implementing IEEE 802.15.4 may operate on multiple sub-GHz or 2.4 GHz channels. Each frequency band or channel provides independent motion detection measurements, and the central aggregator can apply bidirectional correlation across both frequency bands or channels for a given spatial link. This multi-band or multi-channel approach provides additional noise rejection capability because radio noise events are often frequency-specific.

In further embodiments, the multi-sensor collaborative processing described above may be combined with additional frequency diversity, multi-band operation, or multi-channel wireless sensing. For example, wireless transceivers implementing IEEE 802.11 may maintain bidirectional links on both the 2.4 GHz and 5 GHz bands, while auxiliary sensors provide independent confirmation or classification of motion events. Each frequency band, wireless channel, or auxiliary sensor modality provides an additional source of evidence that may be evaluated by the central aggregator to improve noise rejection and motion-state confidence.

The specific numerical parameters disclosed herein (such as frequency bands, thresholds, time windows, and weighting factors) are exemplary and may be adjusted based on deployment environment, application requirements, and hardware characteristics. For example, the bidirectional correlation thresholds may be set higher in high-noise environments or lower in low-noise environments. The motion transition threshold for temporal correlation may be set to shorter values (e.g., 0.5 seconds) in applications requiring very fast response or longer values (e.g., 3 seconds) in applications where user movement is typically slower. The data aggregation interval may be reduced to 10 milliseconds or less for ultra-low-latency applications or increased to 200 milliseconds or more in power-constrained deployments where reducing wireless transmission overhead is important.

The processing algorithms described herein may be implemented in various forms including software executing on general-purpose processors, firmware executing on embedded microcontrollers, dedicated hardware logic circuits (such as FPGAs or ASICs), or hybrid combinations thereof. The choice of implementation depends on factors such as cost, power consumption, processing latency requirements, and flexibility for future updates. In typical commercial products, the transceiver-level processing (generating intermediate motion detection results) is implemented in firmware on low-cost microcontrollers integrated with the wireless radio chipset, while the central aggregator processing (bidirectional correlation, temporal correlation, and weighted voting) is implemented in software on a more powerful processor such as an ARM Cortex-A series application processor or an embedded Linux system.

The invention is applicable to a wide range of applications including but not limited to: smart home automation systems (automated lighting, HVAC control, security monitoring), elderly care and healthcare monitoring (fall detection, activity tracking, sleep monitoring), commercial building management (occupancy-based energy optimization, space utilization analytics), retail analytics (customer traffic patterns, dwell time measurement), and security systems (intrusion detection, perimeter monitoring). The specific configuration and parameter settings may be optimized for each application based on the expected motion characteristics, environmental conditions, and performance requirements.

Within embodiments of the invention processing may be performed by one or more artificial intelligence based process, algorithms or systems and/or one or more machine learning processes, algorithms or systems.

According to an embodiment of the invention there is provided a method of providing a wireless motion detection system comprising:
establishing a sensing layer comprising a number of wireless sensing links between a number of wireless devices associated with an environment where a portion of the number of wireless devices comprise either a wireless receiver or a wireless transceiver for receiving wireless signals or wireless packets from either one or more other wireless transceivers within the portion of the number of wireless devices or one or more wireless transmitters within another portion of the number of wireless devices;
transmitting propagation-sensitive wireless measurements from each wireless device of the portion of the number of wireless devices which comprise either a wireless receiver or a wireless transceiver to a central aggregator via a number of links forming a coordination layer; and
executing a process upon the central aggregator comprising the steps of:
   receiving the motion-related wireless measurement data from each wireless device of the portion of the number of wireless devices which is either a wireless receiver or a wireless transceiver from the number of links forming the coordination layer;
   perform collaborative processing by analyzing the motion-related wireless measurement data from multiple spatially related wireless sensing links together; and
   determine a motion state based on simultaneous collaborative analysis of the motion-related wireless measurement data from the plurality of wireless sensing links; wherein
each wireless device of the portion of the number of wireless devices comprising either the wireless receiver or the wireless transceiver extracts wireless signal characteristics from the received wireless packets or signals received over the wireless sensing link of the number of wireless sensing links comprising either the wireless receiver or the wireless transceiver and establishes propagation-sensitive wireless measurements independence upon the extracted wireless signal characteristics.

According to an embodiment of the invention the motion-related wireless measurement data comprises at least one of raw measurements, partially processed measurements, feature vectors, statistical summaries, signal disturbance metrics, time-stamped event candidates, confidence values, intermediate motion detection results, or combinations thereof.

According to an embodiment of the invention the extracted wireless signal characteristics comprise one or more of channel state information (CSI) amplitude, CSI phase, received signal strength indicator (RSSI), received signal strength, link-quality information, channel-response information, Doppler-related information, time-of-flight information, or combinations thereof.

According to an embodiment of the invention the coordination network operates according to one or more coordination protocols selected from the group consisting of IEEE 802.11, IEEE 802.15.4, Zigbee, Thread, Bluetooth Low Energy, Z-Wave, Ethernet, and sub-GHz protocols;

According to an embodiment of the invention each wireless sensing link of the number of wireless sensing links forming the sensing layer operates according to a wireless protocol selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Thread, Wi-Fi, Ultra-Wideband and WiMAX.

According to an embodiment of the invention then at least one wireless sensing link of the number of wireless sensing links is a bidirectional communication link comprising a forward transmission path and a reverse transmission path, and the central aggregator executes another process comprising the steps of:
calculating a signal disturbance metric for the forward transmission path and a signal disturbance metric for the reverse transmission path of the at least one bidirectional communication link;
compare the forward transmission path signal disturbance metric to a first predetermined threshold and compare the reverse transmission path signal disturbance metric to a second predetermined threshold; and
either:
   generate or increase a confidence of a motion detection signal established by the central aggregator generated by the central aggregator for the at least one bidirectional communication link when both the forward transmission path signal disturbance metric exceeds the first predetermined threshold and the reverse transmission path signal disturbance metric exceeds the second predetermined threshold;
or:
   reject or decrease a confidence of a motion detection signal established by the central aggregator generated by the central aggregator for the at least one bidirectional communication link when either the forward transmission path signal disturbance metric does not exceed the first predetermined threshold or the reverse transmission path signal disturbance metric does not exceed the second predetermined threshold.

According to an embodiment of the invention the central aggregator further comprises a temporal correlation module configured to:
record, upon detection of a motion event on a first wireless sensing link of the number of wireless sensing links at a first time T1 an identity of the first wireless sensing link, the first time T1, and a spatial location of the first wireless sensing link of the number of wireless sensing links within the environment;
calculate, upon detection of a motion event on a second wireless sensing link at a second time T2, a time difference ΔT equal to T2 minus T1;
determine whether the second wireless sensing link of the number of wireless sensing links is spatially adjacent to the first wireless sensing link of the number of wireless sensing links by determining whether either the two links share at least one common wireless device or a physical distance between the wireless devices at either end of the first wireless sensing link and the second wireless sensing link is below a predetermined spatial threshold; and
maintain motion state continuity by recognizing the signal disturbances on the second wireless sensing link of the number of wireless sensing links as a continuation of the motion event on the first wireless sensing link of the number of wireless sensing links when ΔT is less than a predetermined motion transition threshold and the second wireless sensing link of the number of wireless sensing links is spatially adjacent to the first wireless sensing link of the number of wireless sensing links.

According to an embodiment of the invention the central aggregator is further configured to execute a weighted voting algorithm comprising:
calculating, for each wireless sensing link i, a weighting factor Wᵢ based on at least one of: a signal-to-noise ratio of the wireless sensing link, a link stability metric comprising a packet loss rate of the wireless sensing link, and a spatial coverage factor indicating a likelihood of motion occurrence on the wireless sensing link;
computing a weighted contribution Cᵢ for each wireless sensing link i as the product of the weighting factor Wᵢ and a motion-related measurement value or intermediate motion detection result Mᵢ for that link; and
computing a final motion score as a weighted average equal to the sum of all weighted contributions Cᵢ divided by the sum of all weighting factors Wᵢ, and determining the motion state by comparing the final motion score to a predetermined decision threshold.

According to an embodiment of the invention the propagation-sensitive wireless measurements comprise at least one of channel state information (CSI) amplitude measurements, CSI phase measurements, received signal strength indicator (RSSI), received signal strength, link-quality measurements, channel-response measurements, Doppler-related measurements, or time-of-flight measurements, and wherein the signal disturbance metric for each transmission path or wireless sensing link is computed as a statistical measure of variation over a sliding time window, the statistical measure being selected from the group consisting of variance, standard deviation, rate of change, temporal derivative, spectral feature, and Doppler-related feature.

According to an embodiment of the invention each wireless transceiver is configured to transmit raw measurements, partially processed measurements, feature vectors, statistical summaries, signal disturbance metrics, or intermediate motion detection results to the central aggregator at defined intervals wherein the interval is between 10 milliseconds and 5 seconds.

According to an embodiment of the invention central aggregator is implemented as part of one of the plurality of wireless transceivers, such that the central aggregator performs dual functions as both a wireless transceiver maintaining at least one wireless sensing link and a central processing hub receiving and analyzing motion-related wireless measurement data or intermediate motion detection results from multiple wireless sensing links.

According to an embodiment of the invention the central aggregator is implemented as distributed processing logic replicated across two or more of the plurality of wireless transceivers wherein each of the two or more wireless transceivers performs partial aggregation of intermediate motion detection results from neighboring or spatially related wireless sensing links and exchanges aggregated data with peer wireless transceivers through the coordination network to achieve collaborative motion state determination without a single centralized processing point.

According to an embodiment of the invention the central aggregator is further configured to adaptively adjust at least one of the first predetermined threshold and the second predetermined threshold in dependence upon historical noise statistics observed on each transmission path of each bidirectional communication link, the historical noise statistics comprising at least one of baseline noise levels during periods of no motion, frequency of unidirectional noise events, and magnitude of unidirectional noise events, thereby dynamically optimizing detection sensitivity in response to changing environmental conditions.

According to an embodiment of the invention the temporal correlation module implements a state machine that maintains, for the sensing layer, a list of wireless sensing links currently experiencing motion, a timestamp of the most recent motion detection event on each link, a predicted motion trajectory based on a sequence of link activations, and a confidence score for a continuous motion hypothesis, the state machine being updated in real-time as new intermediate motion detection results are received from the wireless transceivers.

According to an embodiment of the invention the weighting factor Wᵢ for each wireless sensing link i is computed as Wi=α⋅W_SNR(i)+β⋅W_Stability(i)+γ⋅W_Spatial(i) wherein W_SNR(i) is a normalized signal-to-noise ratio component, W_Stability(i) is computed as one minus a packet loss rate of the link i, W_Spatial(i) is an application-specific spatial coverage factor, and α, β, γ.

According to an embodiment of the invention wireless transceivers within the number of wireless devices are configured to maintain bidirectional communication links simultaneously on a first wireless frequency band and a second wireless frequency band different from the first wireless frequency band, and wherein the processing circuitry is further configured to apply bidirectional correlation analysis across both the first wireless frequency band and the second wireless frequency band for each spatial link, such that a motion detection signal is generated only when signal disturbances are detected on both frequency bands, thereby providing additional noise rejection for frequency-specific interference events.

According to an embodiment of the invention a multi-sensor correlation module configured to receive auxiliary sensor data from at least one auxiliary sensor selected from the group consisting of a passive infrared sensor, a millimeter wave radar sensor, an ultrasonic sensor, a thermal array sensor, an acoustic sensor, a contact sensor, a camera-based vision sensor, and an environmental sensor, wherein the central aggregator is further configured to fuse the auxiliary sensor data with the motion-related wireless measurement data from the plurality of wireless sensing links using a multi-modal correlation algorithm to determine at least one of a motion state, a presence state, an occupancy state, an activity level, a zone-transition event, a direction-of-travel estimate, a trajectory estimate, and an associated likelihood or confidence value.

According to an embodiment of the invention the auxiliary sensor data comprises at least one of a sensor identifier, a timestamp, a spatial coverage region, a sensor disturbance metric, an optional sensor confidence value, a motion classification, a presence indication, an occupancy indication, a detected object range, a detected object velocity, a Doppler feature, a thermal change value, or a binary trigger state, and wherein the multi-sensor correlation module determines whether the auxiliary sensor data and the wireless-link data correspond to a common physical motion event based on temporal overlap and spatial coverage overlap.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of providing a wireless motion detection system comprising:
establishing a sensing layer comprising a number of wireless sensing links between a number of wireless devices associated with an environment where a portion of the number of wireless devices comprise either a wireless receiver or a wireless transceiver for receiving wireless signals or wireless packets from either one or more other wireless transceivers within the portion of the number of wireless devices or one or more wireless transmitters within another portion of the number of wireless devices;
transmitting propagation-sensitive wireless measurements from each wireless device of the portion of the number of wireless devices which comprise either a wireless receiver or a wireless transceiver to a central aggregator via a number of links forming a coordination layer; and
executing a process upon the central aggregator comprising the steps of:
receiving the motion-related wireless measurement data from each wireless device of the portion of the number of wireless devices which is either a wireless receiver or a wireless transceiver from the number of links forming the coordination layer;
perform collaborative processing by analyzing the motion-related wireless measurement data from multiple spatially related wireless sensing links together; and
determine a motion state based on simultaneous collaborative analysis of the motion-related wireless measurement data from the plurality of wireless sensing links; wherein
each wireless device of the portion of the number of wireless devices comprising either the wireless receiver or the wireless transceiver extracts wireless signal characteristics from the received wireless packets or signals received over the wireless sensing link of the number of wireless sensing links comprising either the wireless receiver or the wireless transceiver and establishes propagation-sensitive wireless measurements independence upon the extracted wireless signal characteristics.

2. The method according to claim 1, wherein
the motion-related wireless measurement data comprise at least one of raw measurements, partially processed measurements, feature vectors, statistical summaries, signal disturbance metrics, time-stamped event candidates, confidence values, intermediate motion detection results, or combinations thereof.

3. The method according to claim 1, wherein
the extracted wireless signal characteristics comprise one or more of channel state information (CSI) amplitude, CSI phase, received signal strength indicator (RSSI), received signal strength, link-quality information, channel-response information, Doppler-related information, time-of-flight information, or combinations thereof.

4. The method according to claim 1, wherein
the coordination network operates according to one or more coordination protocols selected from the group consisting of IEEE 802.11, IEEE 802.15.4, Zigbee, Thread, Bluetooth Low Energy, Z-Wave, Ethernet, and sub-GHz protocols.

5. The method according to claim 1, wherein
each wireless sensing link of the number of wireless sensing links forming the sensing layer operates according to a wireless protocol selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Thread, Wi-Fi, Ultra-Wideband and WiMAX.

6. The method according to claim 1, wherein
at least one wireless sensing link of the number of wireless sensing links is a bidirectional communication link comprising a forward transmission path and a reverse transmission path, and the central aggregator executes another process comprising the steps of:
calculating a signal disturbance metric for the forward transmission path and a signal disturbance metric for the reverse transmission path of the at least one bidirectional communication link;
compare the forward transmission path signal disturbance metric to a first predetermined threshold and compare the reverse transmission path signal disturbance metric to a second predetermined threshold; and
either:
generate or increase a confidence of a motion detection signal established by the central aggregator generated by the central aggregator for the at least one bidirectional communication link when both the forward transmission path signal disturbance metric exceeds the first predetermined threshold and the reverse transmission path signal disturbance metric exceeds the second predetermined threshold;
or:
reject or decrease a confidence of a motion detection signal established by the central aggregator generated by the central aggregator for the at least one bidirectional communication link when either the forward transmission path signal disturbance metric does not exceed the first predetermined threshold or the reverse transmission path signal disturbance metric does not exceed the second predetermined threshold.

7. The method according to claim 1, wherein the central aggregator further comprises a temporal correlation module configured to:
record, upon detection of a motion event on a first wireless sensing link of the number of wireless sensing links at a first time T1 an identity of the first wireless sensing link, the first time T1, and a spatial location of the first wireless sensing link of the number of wireless sensing links within the environment;
calculate, upon detection of a motion event on a second wireless sensing link at a second time T2, a time difference ΔT equal to T2 minus T1;
determine whether the second wireless sensing link of the number of wireless sensing links is spatially adjacent to the first wireless sensing link of the number of wireless sensing links by determining whether either the two links share at least one common wireless device or a physical distance between the wireless devices at either end of the first wireless sensing link and the second wireless sensing link is below a predetermined spatial threshold; and
maintain motion state continuity by recognizing the signal disturbances on the second wireless sensing link of the number of wireless sensing links as a continuation of the motion event on the first wireless sensing link of the number of wireless sensing links when ΔT is less than a predetermined motion transition threshold and the second wireless sensing link of the number of wireless sensing links is spatially adjacent to the first wireless sensing link of the number of wireless sensing links.

8. The method according to claim 1, wherein the central aggregator circuitry is further configured to execute a weighted voting algorithm comprising:
calculating, for each wireless sensing link i, a weighting factor Wᵢ based on at least one of:
a signal-to-noise ratio of the wireless sensing link, a link stability metric comprising a packet loss rate of the wireless sensing link, and a spatial coverage factor indicating a likelihood of motion occurrence on the wireless sensing link;
computing a weighted contribution Cᵢ for each wireless sensing link i as the product of the weighting factor Wᵢ and a motion-related measurement value or intermediate motion detection result Mᵢ for that link; and
computing a final motion score as a weighted average equal to the sum of all weighted contributions Cᵢ divided by the sum of all weighting factors Wᵢ, and determining the motion state by comparing the final motion score to a predetermined decision threshold.

9. The method according to claim 1, wherein
the propagation-sensitive wireless measurements comprise at least one of channel state information (CSI) amplitude measurements, CSI phase measurements, received signal strength indicator (RSSI), received signal strength, link-quality measurements, channel-response measurements, Doppler-related measurements, or time-of-flight measurements, and wherein the signal disturbance metric for each transmission path or wireless sensing link is computed as a statistical measure of variation over a sliding time window, the statistical measure being selected from the group consisting of variance, standard deviation, rate of change, temporal derivative, spectral feature, and Doppler-related feature.

10. The method according to claim 1, wherein
each wireless transceiver is configured to transmit raw measurements, partially processed measurements, feature vectors, statistical summaries, signal disturbance metrics, or intermediate motion detection results to the central aggregator at defined intervals; wherein
the interval is between 10 milliseconds and 5 second.

11. The method according to claim 1, wherein
the central aggregator is implemented as part of one of the plurality of wireless transceivers, such that the central aggregator performs dual functions as both a wireless transceiver maintaining at least one wireless sensing link and a central processing hub receiving and analyzing motion-related wireless measurement data or intermediate motion detection results from multiple wireless sensing links.

12. The method according to claim 1, wherein
the central aggregator is implemented as distributed processing logic replicated across two or more of the plurality of wireless transceivers, wherein
each of the two or more wireless transceivers performs partial aggregation of intermediate motion detection results from neighboring or spatially related wireless sensing links and exchanges aggregated data with peer wireless transceivers through the coordination network to achieve collaborative motion state determination without a single centralized processing point.

13. The method according to claim 6, wherein
the central aggregator is further configured to adaptively adjust at least one of the first predetermined threshold and the second predetermined threshold in dependence upon historical noise statistics observed on each transmission path of each bidirectional communication link, the historical noise statistics comprising at least one of baseline noise levels during periods of no motion, frequency of unidirectional noise events, and magnitude of unidirectional noise events, thereby dynamically optimizing detection sensitivity in response to changing environmental conditions.

14. The method according to claim 8, wherein
the temporal correlation module implements a state machine that maintains, for the sensing layer, a list of wireless sensing links currently experiencing motion, a timestamp of the most recent motion detection event on each link, a predicted motion trajectory based on a sequence of link activations, and a confidence score for a continuous motion hypothesis, the state machine being updated in real-time as new intermediate motion detection results are received from the wireless transceivers.

15. The method according to claim 8, wherein
the weighting factor Wᵢ for each wireless sensing link i is computed as Wᵢ=α⋅W_SNR(i)+β⋅W_Stability(i)+γ⋅W_Spatial(i) wherein W_SNR(i) is a normalized signal-to-noise ratio component, W_Stability(i) is computed as one minus a packet loss rate of the link i, W_Spatial(i) is an application-specific spatial coverage factor, and α, β, γ.

16. The method according to claim 1, wherein
wireless transceivers within the number of wireless devices are configured to maintain bidirectional communication links simultaneously on a first wireless frequency band and a second wireless frequency band different from the first wireless frequency band, and wherein the processing circuitry is further configured to apply bidirectional correlation analysis across both the first wireless frequency band and the second wireless frequency band for each spatial link, such that a motion detection signal is generated only when signal disturbances are detected on both frequency bands, thereby providing additional noise rejection for frequency-specific interference events.

17. The method according to claim 1, further comprising
a multi-sensor correlation module configured to receive auxiliary sensor data from at least one auxiliary sensor selected from the group consisting of a passive infrared sensor, a millimeter wave radar sensor, an ultrasonic sensor, a thermal array sensor, an acoustic sensor, a contact sensor, a camera-based vision sensor, and an environmental sensor, wherein
the central aggregator is further configured to fuse the auxiliary sensor data with the motion-related wireless measurement data from the plurality of wireless sensing links using a multi-modal correlation algorithm to determine at least one of a motion state, a presence state, an occupancy state, an activity level, a zone-transition event, a direction-of-travel estimate, a trajectory estimate, and an associated likelihood or confidence value.

18. The method according to claim 17, wherein
each auxiliary sensor data comprises at least one of a sensor identifier, a timestamp, a spatial coverage region, a sensor disturbance metric, an optional sensor confidence value, a motion classification, a presence indication, an occupancy indication, a detected object range, a detected object velocity, a Doppler feature, a thermal change value, or a binary trigger state, and wherein the multi-sensor correlation module determines whether the auxiliary sensor data and the wireless-link data correspond to a common physical motion event based on temporal overlap and spatial coverage overlap.
